(19) United States
(12) Patent Application Publication
(10) Pub. No.: US 2019/0147611 A1
(43) Pub. Date: May 16, 2019

(54) OBJECT SENSING SYSTEM, OBJECT SENSING METHOD, AND RECORDING MEDIUM STORING PROGRAM CODE

(71) Applicant: Makoto SHINNISHI, Kanagawa (JP)

(72) Inventor: Makoto SHINNISHI, Kanagawa (JP)

(21) Appl. No.: 16/177,598

(22) Filed: Nov. 1, 2018

(30) Foreign Application Priority Data
Nov. 10, 2017 (JP) 2017-217020
Oct. 19, 2018 (JP) 2018-197297

(51) Int. Cl. G06T 7/70

(52) U.S. Cl. CPC G06T 7/70; G06T 2207/30196

(57) ABSTRACT

An object sensing system, an object sensing method, and a recording medium storing a program. The object sensing system and the object sensing method include transmitting a signal of identification information of the object, using an identification information transmitter attached to the object, receiving the signal of the identification information transmitted from the identification information transmitter, using a detector, detecting the object based on the signal of the identification information obtained in the receiving, using the detector, capturing the object using an imaging device, performing image processing on the object when the object is detected by the detector within the capturing range of the imaging device, the image processing being performed differently when the object is not detected by the detector within the capturing range of the imaging device, and estimating at least a position of the object. The program causes a computer to execute the object sensing method.

### CROSS-REFERENCE TO RELATED APPLICATIONS

This patent application is based on and claims priority pursuant to 35 U.S.C. § 119(a) to Japanese Patent Application Nos. 2017-217020 and 2018-197297, filed on Nov. 10, 2017, and Oct. 19, 2018, respectively, in the Japan Patent Office, the entire disclosures of which are hereby incorporated by reference herein.

### BACKGROUND

### Technical Field

Embodiments of the present disclosure relate to an object sensing system, an object sensing method, and a recording medium storing program code for causing a computer to execute the object sensing method.

### Background Art

Wireless communication systems are known in the art that use a Bluetooth Low Energy (BLE) device that transmits a radio or radar signal based on Bluetooth (registered trademark) wireless communication technology or a device that adopts Wi-Fi (registered trademark) wireless communication technology. For such wireless communication systems, technologies are known in the art to detect an object (for example, a person) carrying equipment (this may be referred to as a tag in the following description) that transmits a radio or radar signal, by receiving a radio or radar signal with a receiver, and to estimate an area based on the received radio field intensity or the like. Technologies are also proposed that estimate, for example, the active mass, behavior, and posture of the object based on the values obtained from various kinds of sensors provided for the tag carried by the object (for example, the value of acceleration, angular velocity, air pressure, or earth magnetism).

Moreover, as a method of sensing such an object or estimating the position or posture of the object, analyzing technologies are known in the art that use the images captured by a surveillance camera or the like arranged at a specific point.

Technologies to estimate the behavior of an object in a not-captured area are proposed. For example, a configuration is known in the art that uses a behavior estimation model to recognize the behavior of an object person even when he/she is in a blind spot.

### SUM MARY

Embodiments of the present disclosure described herein provide an object sensing system, an object sensing method, and a recording medium storing a program. The object sensing system and the object sensing method include transmitting a signal of identification information of the object, using an identification information transmitter attached to the object, receiving the signal of the identification information transmitted from the identification information transmitter, using a detector, detecting the object based on the signal of the identification information obtained in the receiving, using the detector, capturing the object using an imaging device, performing image processing on the object when the object is detected by the detector within the capturing range of the imaging device, the image processing being performed differently when the object is not detected by the detector within the capturing range of the imaging device, and estimating at least a position of the object. The program causes a computer to execute the object sensing method.

### BRIEF DESCRIPTION OF THE DRAWINGS

A more complete appreciation of exemplary embodiments and the many attendant advantages thereof will be readily obtained as the same becomes better understood by reference to the following detailed description when considered in connection with the accompanying drawings.

FIG. 1 is a diagram illustrating a schematic configuration of an object sensing system according to an embodiment of the present disclosure.

FIG. 2 is a schematic block diagram illustrating a configuration of an object sensing system according to an embodiment of the present disclosure.

FIG. 3 is a block diagram illustrating a configuration of an identification information transmitter (tag) according to an embodiment of the present disclosure.

FIG. 4 is a block diagram illustrating a configuration of a detector that serves as a receiver, according to an embodiment of the present disclosure.

FIG. 5 is a block diagram illustrating a configuration of a server according to an embodiment of the present disclosure.

FIG. 6A is a table depicting the relation between a capturing range of a imaging device and a detectable area of a detector, according to an embodiment of the present disclosure.

FIG. 6B is a schematic diagram illustrating the relation between a capturing range of a imaging device and a detectable area of a detector, according to an embodiment of the present disclosure.

FIG. 7A and FIG. 7B are a flowchart of the processes performed by a server, according to an embodiment of the present disclosure.

FIG. 8 is a diagram illustrating a first mode where the position of an object is estimated.

FIG. 9 is a diagram illustrating a second mode where the position of an object is estimated.

FIG. 10 is a diagram illustrating a third mode where the position of an object is estimated.

FIG. 11 is a diagram illustrating a fourth mode where the position of an object is estimated.

FIG. 12 is a diagram illustrating a fifth mode where the posture of an object is estimated.

FIG. 13 is a diagram illustrating a sixth mode where the position of an object is estimated.

The accompanying drawings are intended to depict exemplary embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that have the same structure, operate in a similar manner, and achieve a similar result.

In the following description, illustrative embodiments will be described with reference to acts and symbolic representations of operations (e.g., in the form of flowcharts) that may be implemented as program modules or functional processes including routines, programs, objects, components, data structures, etc., that perform particular tasks or implement particular abstract data types and may be implemented using existing hardware at existing network elements or control nodes. Such existing hardware may include one or more central processing units (CPUs), digital signal processors (DSPs), application-specific-integrated-circuits (ASICs), field programmable gate arrays (FPGAs), computers or the like. These terms in general may be collectively referred to as processors.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

An object sensing system, an object sensing method, and a recording medium storing program code according to an embodiment of the present disclosure are described below with reference to the drawings.

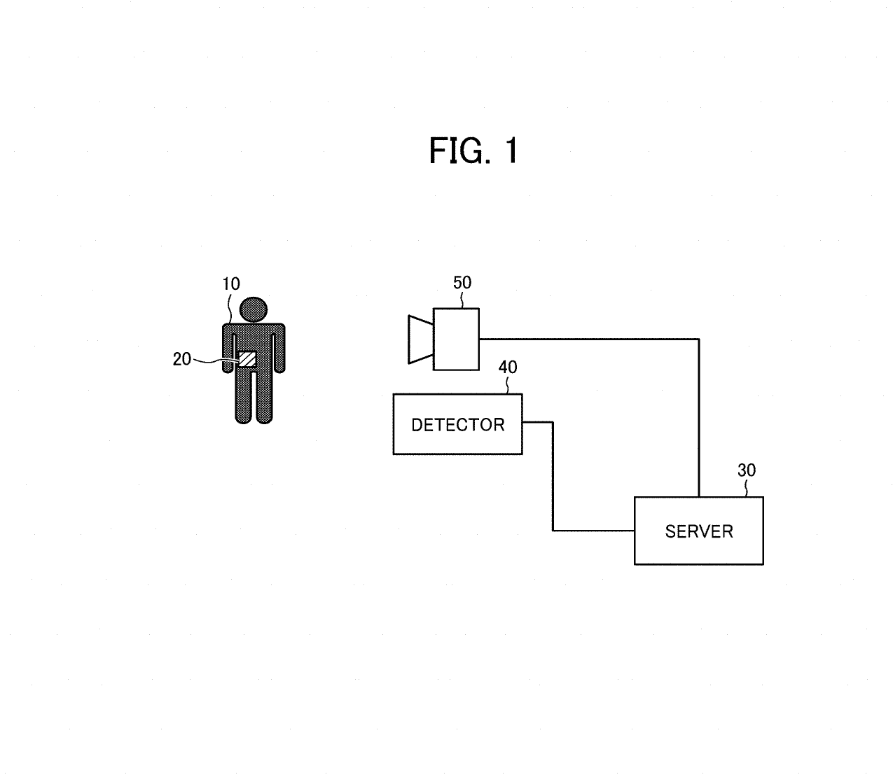

FIG. 1 is a diagram illustrating a schematic configuration of an object sensing system 1 according to an embodiment of the present disclosure.

As illustrated in FIG. 1, the object sensing system 1 is attached to an object 10, and includes an identification information transmitter (which may be referred to as a “tag” in the following description) 20 that emits the identification information of the object 10, a detector 40 that serves as a receiver to receive the identification information signals transmitted from the identification information transmitter 20 and detects the object 10, a imaging device (camera) 50, and a server 30. The server 30 can communicate with the detector 40 and the imaging device 50 through the network. It is desired that the detector 40 include a plurality of detectors, and the detector 40 is arranged at a desired position together with the imaging device 50.

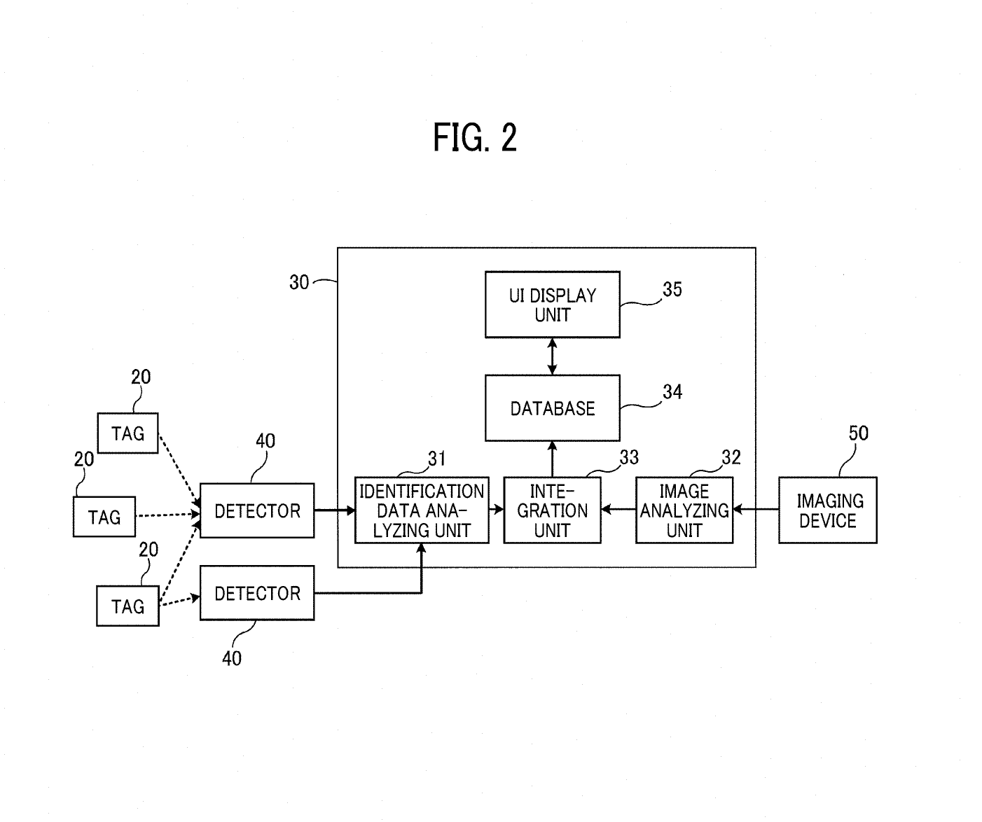

FIG. 2 is a block diagram illustrating a configuration of the object sensing system 1, according to the present embodiment.

The server 30 includes, for example, an identification information analyzer 31 that analyzes various kinds of data included in the identification information received from the detector 40, an image analyzer 32 that analyzes the image data received from the imaging device 50, an integration unit 33 that associates two kinds of data obtained as results of analysis performed by the identification information analyzer 31 and the image analyzer 32, respectively, a database (DB) 34 in which the associated information is registered and stored, and an user interface (UI) display unit 35 that extracts data from the database 34 in response to a request from a user and displays the extracted data.

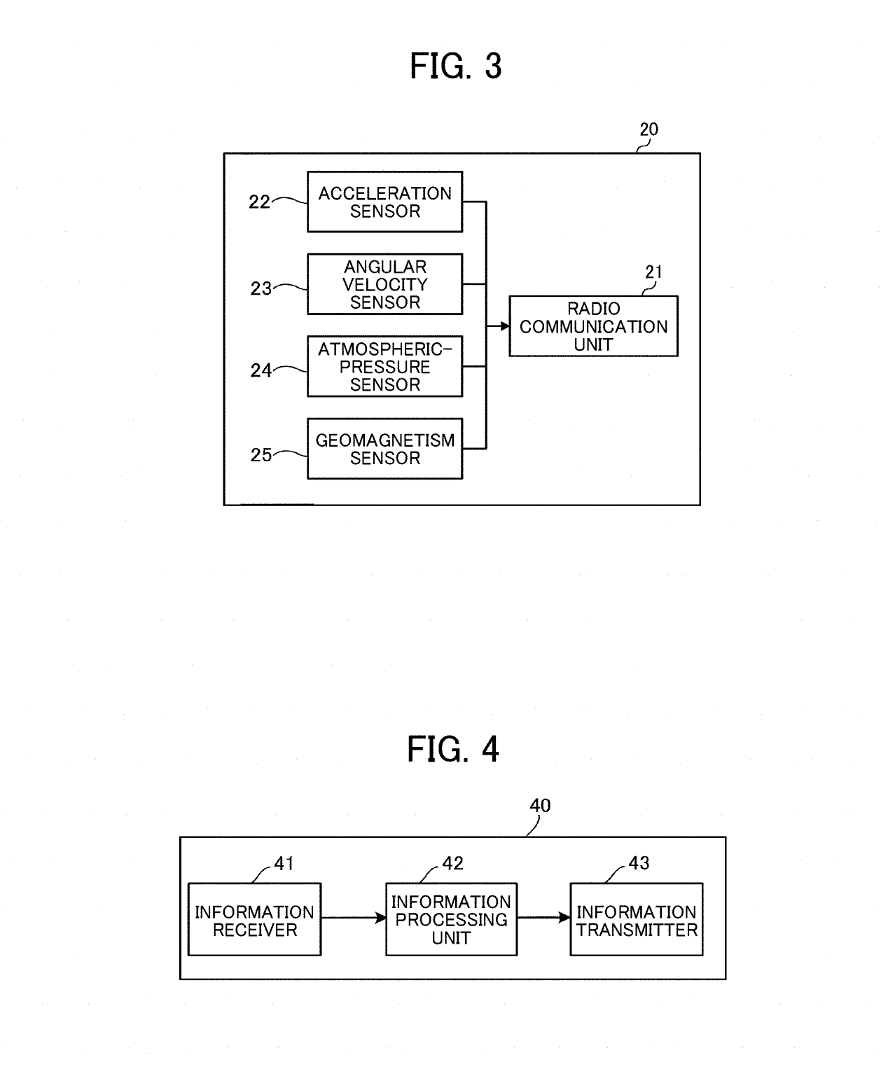

FIG. 3 is a block diagram illustrating a configuration of the identification information transmitter (tag) 20, according to the present embodiment.

The tag 20 is installed with, for example, an acceleration sensor 22 an angular speed sensor 23 an air pressure sensor 24, and a geomagnetic sensor 25. The values output from each of the sensors are sent from a wireless transmitter 21 as sensor data, using, for example, Bluetooth Low Energy (BLE) (registered trademark).

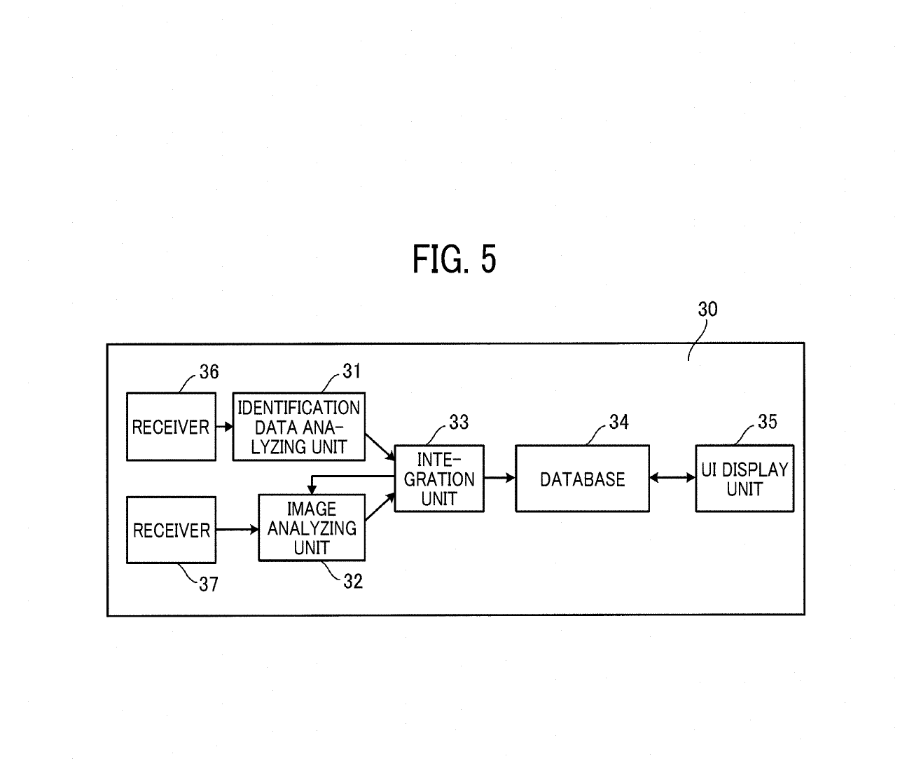

FIG. 4 is a block diagram illustrating a configuration of the detector 40 that serves as a receiver, according to the present embodiment.

The detector 40 includes, for example, a data receiver 41 that receives the identification information transmitted from the tag 20 (which may include the sensor data) an information processor 42 that processes the received identification information or sensor data, and a data transmitter 43 that transmits the processed data to the server 30.

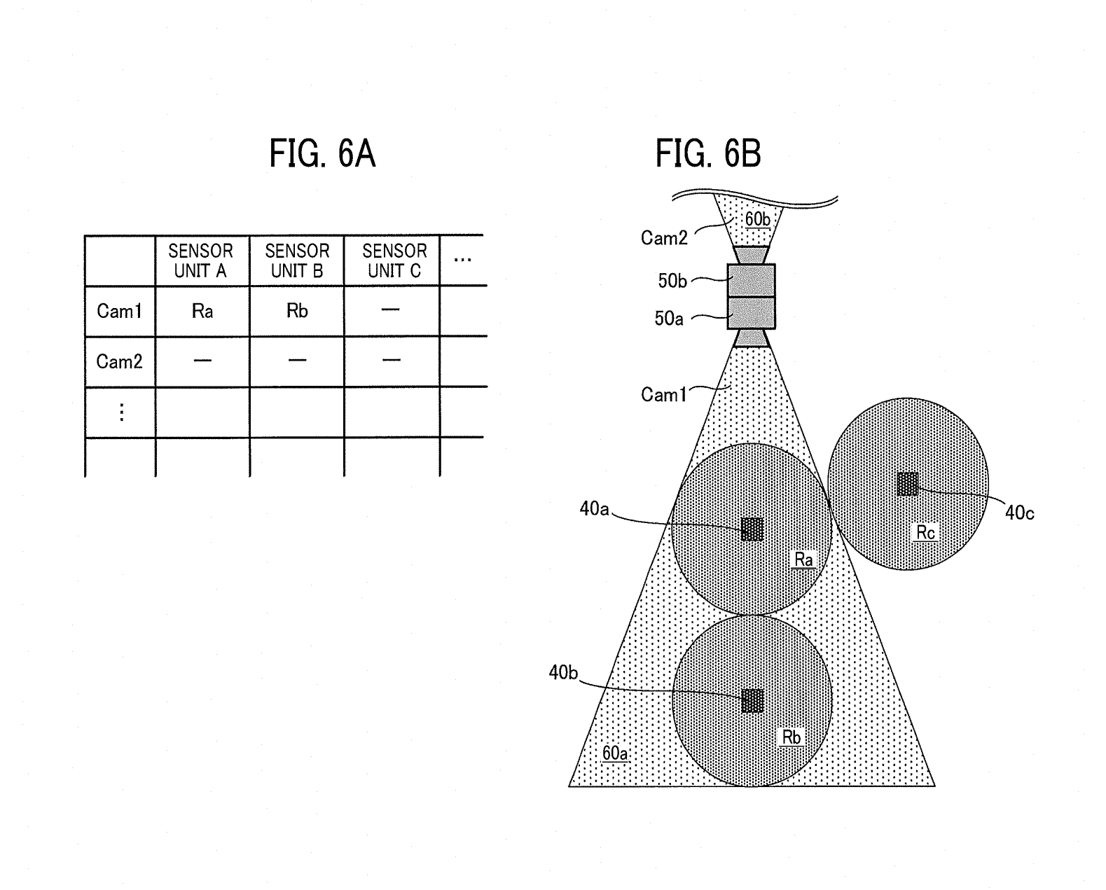

FIG. 5 is a block diagram illustrating a configuration of the server 30, according to the present embodiment.

The server 30 illustrated in FIG. 2 further includes, for example, a receiver 36 that receives data from the detector 40, the identification information analyzer 31 that analyzes the data received from the detector 40, a receiver 37 that receives image data from the imaging device 50, an image analyzer 32 that analyzes the image data received from the imaging device 50, the integration unit 33 that associates two kinds of data obtained as results of analysis performed by the identification information analyzer 31 and the image analyzer 32, respectively, the database (DB) 34 in which the associated information is registered and stored, and the user interface (UI) display unit 35 that extracts data from the database 34 in response to a request from a user and displays the extracted data.

The data to be combined by the integration unit 33 includes, for example, the information of the object 10 that is estimated by the analysis performed by the image analyzer 32, and the information of the object 10 that is transmitted from the tag 20 and then analyzed by the identification information analyzer 31. In other words, the position information or the like of the object 10 estimated by the image analyzer 32 and the identification information of the object 10 (for example, tag ID and position information) are associated with each other by the integration unit 33 and are registered in the database 34 as the associated data.

The server 30 also includes a controller, and the controller controls the image analyzer 32 to perform different processes depending on whether the object 10 is detected by the detector 40 within a capturing range of the imaging device 50. By contrast, when another detector 40 outside the capturing range of the imaging device 50 detects the object 10 the mode is changed by the integration unit 33 and the objects to be analyzed are changed to the images captured by another imaging device 50 that covers the other detector 40 inside the capturing range.

Regarding the processes of estimating the position of the object 10 the processes that are performed by the image analyzer 32 on the image data require much greater computing power than the processes that are performed by the identification information analyzer 31 on the data received by the detector 40. In other words, the data size of the object to be processed and the amount of computation are small in the analysis that involves no image processing, and thus the load of computation is small in the analysis that involves no image processing. By contrast, the data size of the object to be processed and the amount of computation tend to be large in the analysis that involves image processing, and thus the load of computation is heavy in the analysis that involves image processing. For this reason, it is not desired that the image processing be performed by the image analyzer 32 at all times. Instead of a configuration in which the image processing be performed at all times if the image analyzer 32 is controlled to perform image processing only when the object 10 is detected inside the capturing range of the imaging device 50, the speed of the processes can be enhanced, and the cost of computation can be reduced. Accordingly, the required level of computer resource can be reduced, which is preferable. When the object 10 is detected by the detector 40 within a capturing range of the imaging device 50 the image analyzer 32 performs image processing on the object 10. When the object 10 is not detected by the detector 40 within a capturing range of the imaging device 50 the image analyzer 32 is controlled not to perform image processing on the object 10. When the object 10 is detected outside the capturing range of the imaging device 50, the position of the object 10 is estimated by the detector 40.

A method of sensing an object in the above-configured object sensing system according to the present embodiment includes a step of transmitting the identification information of the object 10 using the identification information transmitter (tag) 20 attached to the object 10, a step of detecting the object 10, using the detector 40, upon receiving the signal transmitted from the identification information transmitter 20, a step of capturing the object 10, using the imaging device 50, a step of performing, using the image analyzer 32, image processing on the object 10 when the object 10 is detected by the detector 40 within a capturing range of the imaging device 50, where the image analyzer 32 performs different processes depending on whether or not the object 10 is detected by the detector 40 within a capturing range of the imaging device 50, and a step of estimating a position of the object 10. In other words, only when the object 10 is detected inside the capturing range of the imaging device 50, a step of estimating the position of the object 10 is performed after image processing is performed by the image analyzer 32. When the object 10 is detected outside the capturing range of the imaging device 50, image processing is not performed, and the position of the object 10 is estimated by the detector 40.

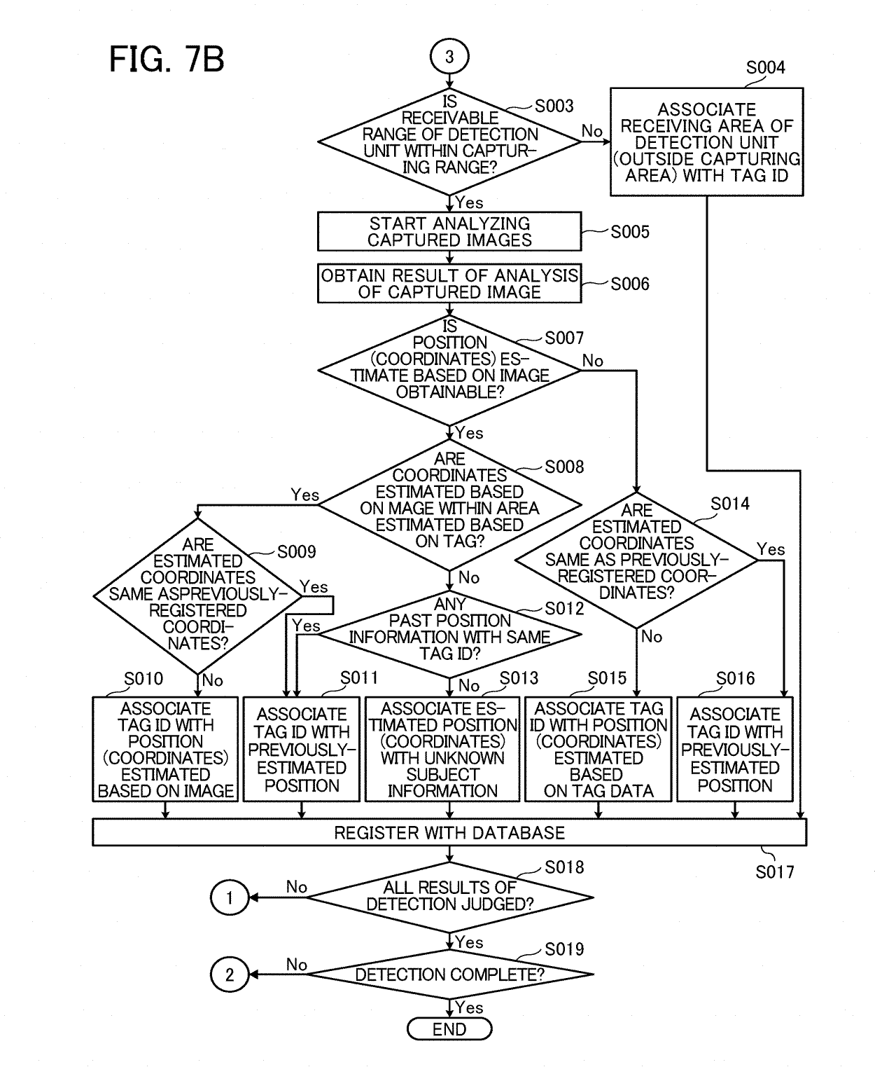

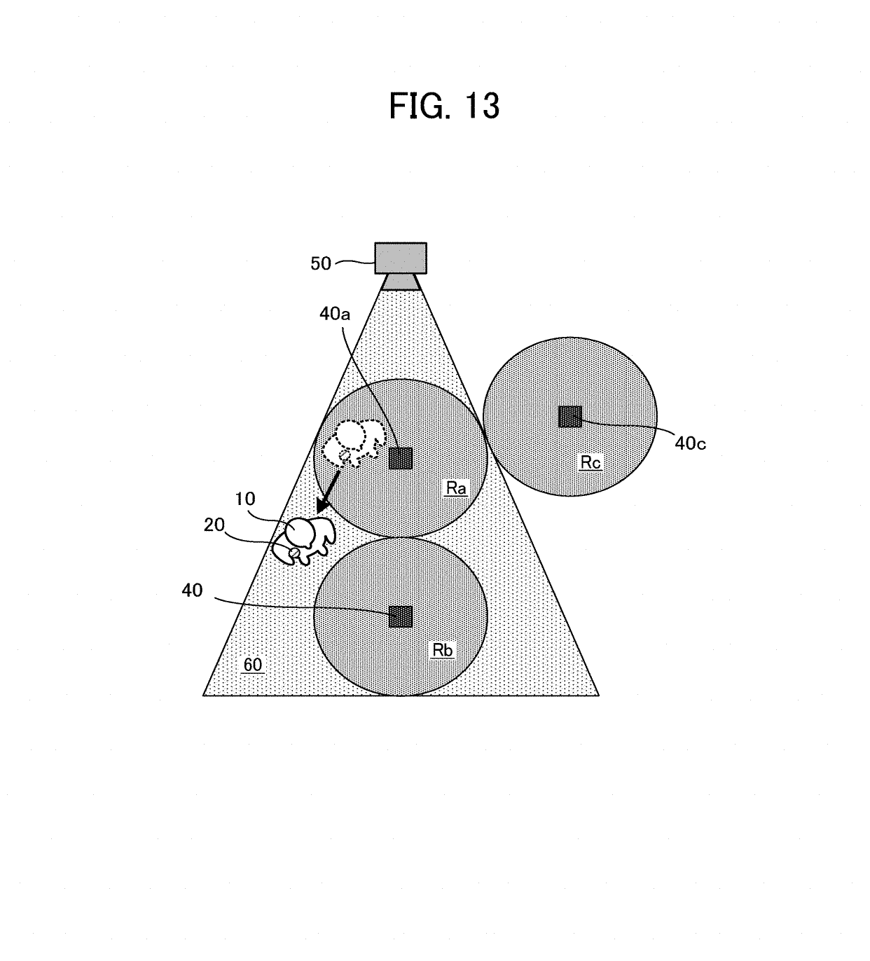

Afterward, when the object 10 that is detected within the capturing range of the imaging device 50 has moved to a position that cannot be detected by the detector 40 within the capturing range of the imaging device 50 in the object sensing system 1 according to the present embodiment, the estimating processes of the position of the object 10 by the image analyzer 32 continue. These processes are described later in detail with reference to FIG. 13 and a step S012 in the flowchart of FIG. 7B.

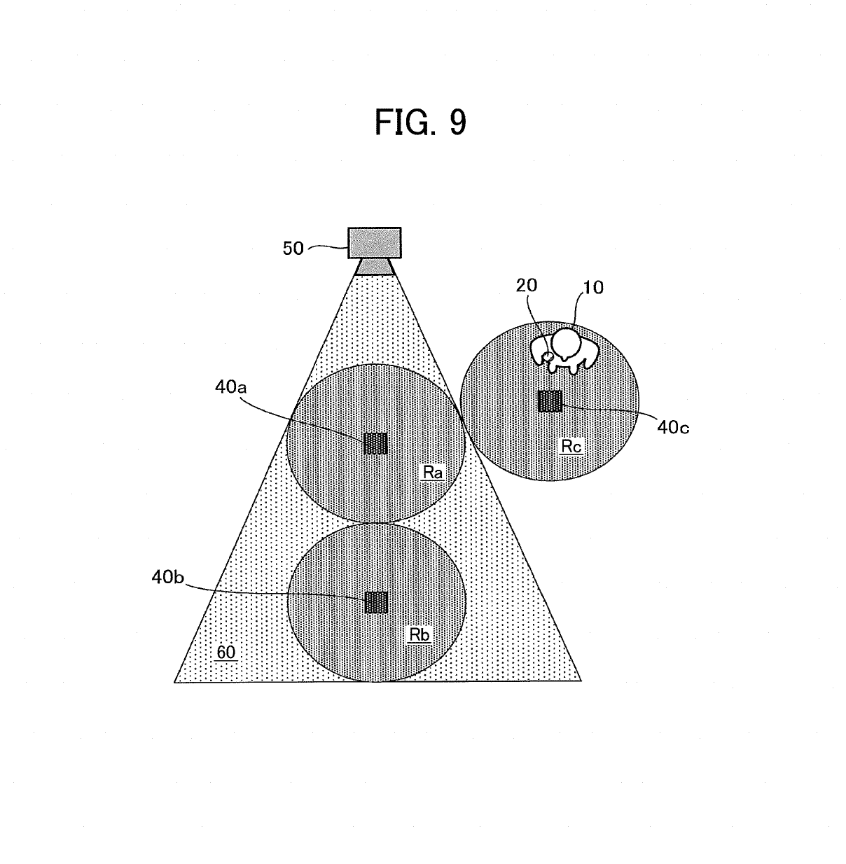

Afterward, when the object 10 that is detected within the capturing range of the imaging device 50 has moved outside the capturing range of the imaging device 50 or has moved to a position that cannot be captured by the imaging device 50, the position of the object 10 is estimated based on the information received by the detector 40. The processes that are performed when the object 10 is detected outside the capturing range of the imaging device 50 are described later in detail with reference to FIG. 9 and a step S004 in the flowchart of FIG. 7B.

The estimation of the position of the object 10 based on the information received by the detector 40 is performed based on the position information of the detector 40 and the level of signal strength received from the identification information transmitter 20.

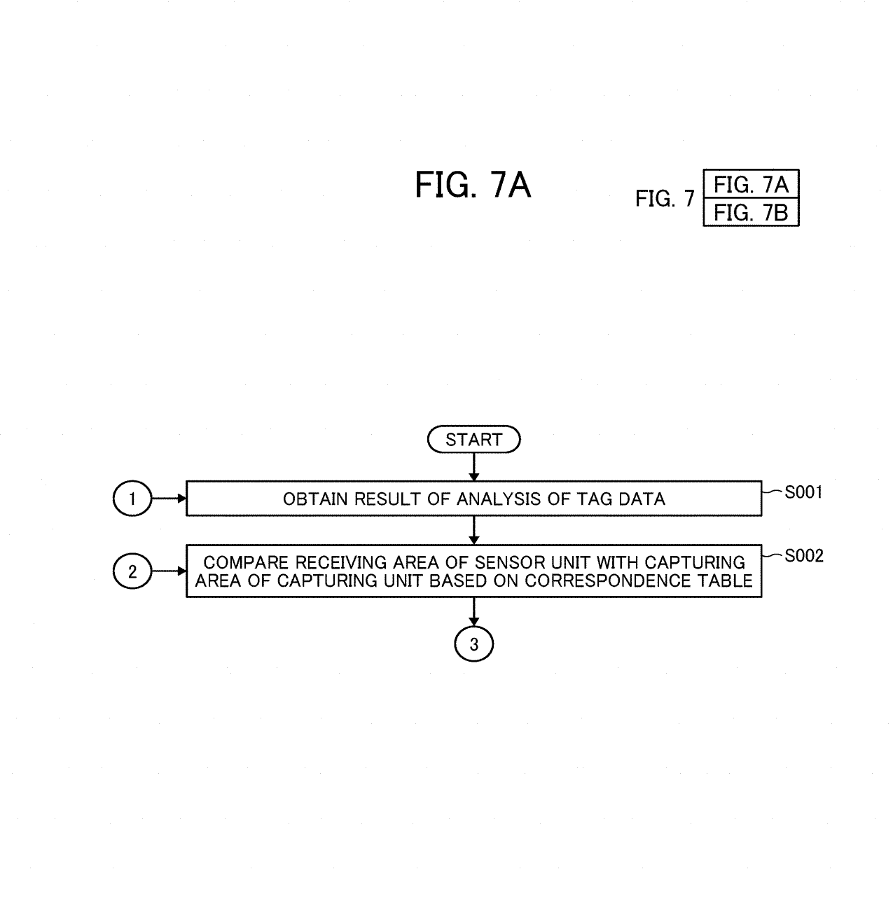

The estimation of the position of the object 10 based on the position information received by the detector 40 are described later in detail with reference to FIG. 6 and a step S002 in the flowchart of FIG. 7A. For example, the distance to the detector 40 can be estimated based on the position information of the detector 40 and the level of signal strength received from the identification information transmitter 20.

The object 10 is, for example, a person. The object sensing system 1 according to the present embodiment may be configured such that the position of the object 10 is estimated and the posture of the object 10 is estimated based on the information received by the detector 40 and/or the image captured by the imaging device 50.

The posture information may additionally be associated with the position information and the identification information of the object 10. Due to this configuration, for example, the object sensing system 1 according to the present embodiment may be applied to the behavior analysis of the picking operation of a worker in a distribution center. For example, the resultant data can be utilized for improving the layout inside the warehouse.

In a similar manner to the position estimating processes, the posture estimating processes of the object 10 may be controlled such that the image analyzer 32 performs image processing and estimation only when the object 10 is detected inside the capturing range of the imaging device 50. Due to this configuration, the speed of the processes can be enhanced, and the cost of computation can be reduced. Accordingly, the required level of computer resource can be reduced, which is preferable. For example, when the object 10 cannot be recognized by the imaging device 50 or when it is difficult to recognize the object 10, the posture of the object 10 may be estimated based on the data obtained from the detector 40.

An example method of estimating the posture based on the data obtained from the detector 40 is described below. Firstly, the inclination of the tag 20 is calculated and obtained based on the acceleration detected by the acceleration sensor 22 provided for the tag 20 and the magnetic north detected by the geomagnetic sensor 25. For example, when the person (i.e., the object 10) takes a bending forward posture, the inclination of the tag 20 takes a value in a prescribed range. Accordingly, when a value in such a prescribed range is detected, it is estimated that the person (i.e., the object 10) has taken a bending forward posture. When the person (i.e., the object 10) takes a bending backward posture, the inclination of the tag 20 takes a value in a prescribed range in the direction opposite to that of the bending forward posture. Accordingly, when a value in such a prescribed range is detected, it is estimated that the person (i.e., the object 10) has taken a bending backward posture.

Alternatively, when the person (i.e., the object 10) squats the air pressure that is detected by the air pressure sensor 24 changes. The air pressure is high on the lower side, and the air pressure is low on the upper side. Accordingly, when the person (i.e., the object 10) squats and an air pressure at a chronologically earlier time is subtracted from an air pressure at a chronologically later time, the obtained air-pressure difference takes a positive value. On the contrary, the air-pressure difference takes a negative value when the person (i.e., the object 10) stands up. A squatting posture is estimated by detecting a pair of an air-pressure peak (positive value) when squatting and an air-pressure peak (negative value) when the person (i.e., the object 10) stands up after the squatting. Although squatting is recognized after the standing up action is done the period of time between the start of squatting and the standing up action is estimated as a squat posture afterward.

Other postures are estimated as follows.

Walking

A walking posture is estimated based on the acceleration detected by the acceleration sensor 22 and the angular speed detected by the angular speed sensor 23. For example, when acceleration equal to or greater than a predetermined value in the up-and-down directions is detected and side-to-side swinging (rolling) unique to human walking is detected, it is estimated that the person (i.e., the object 10) has walked.

Moving Up and Down Stairs

When the person (i.e., the object 10) moves up and down the stairs, acceleration and angular speed are detected in a similar manner to the detection of walking. In the case of going up-and-down the stairs the air pressure further changes and acceleration in the up-and-down directions, which cannot be caused by walking, is caused. Accordingly, when side-to-side swing equivalent to walking, acceleration in the up-and-down directions, which is stronger than walking, and changes in air pressure are detected, a posture of going up-and-down the stairs is estimated. Note also that the reduction in air pressure indicates going up the stairs, and the increase in air pressure indicates going down the stairs.

Seated

When the person (i.e., the object 10) is seated, acceleration is firstly detected in the downward direction and then stability is detected. After the person (i.e., the object 10) is seated, the inclination of the tag 20 becomes stable at a value different from the reference value. Accordingly, it is estimated that the person (i.e., the object 10) is seated when acceleration is firstly detected in the downward direction, stability is then detected, and finally the inclination becomes stable at a value different from the reference value.

FIG. 6A and FIG. 6B are diagrams illustrating the relation between a capturing range of the imaging device 50 and a detectable area of the detector 40.

FIG. 6A is a table depicting the relation between a capturing range of the imaging device 50 and a detectable area of the detector 40, according to the present embodiment.

FIG. 6B is a top-view schematic diagram illustrating the relation between a capturing range of the imaging device 50 and a detectable area of the detector 40, according to the present embodiment.

In FIG. 6B, an example case is illustrated in which two cameras are arranged as the imaging device 50. However, no limitation is intended thereby, and the number of cameras or the positions at which those cameras are arranged are not limited. In FIG. 6B, a capturing range 60a of a imaging device 50a and a capturing range 60b of a imaging device 50b are referred to as Cam 1 and Cam 2, respectively.

As illustrated in FIG. 6A and FIG. 6B, two detectors A and B (40a and 40b) are arranged within the capturing range 60a (Cam 1) of the imaging device (camera) 50a so as to detect the object 10. In FIG. 6B, a range in which the detector A (40a) can receive a signal and a range in which the detector B (40b) can receive a signal are referred to as Ra and Rb, respectively. Further, a detector C (40c) is arranged outside the capturing range 60a (Cam 1), and in FIG. 6B, a range in which the detector C (40c) can receive a signal is referred to as Rc

The table of FIG. 6A depicts the relation between the capturing ranges of imaging devices and the detectable areas of detectors, according to the present embodiment. In the object sensing system 1 according to the present embodiment, the server 30 refers to this table when data is integrated. In the present embodiment only when the object 10 is detected by the detector 40 within a capturing range of the imaging device 50, the image analyzer 32 is controlled to perform image processing. Accordingly, the table is referred to in order to control the image analyzer to execute image processing only when the detector 40 that is arranged so as to detect the object 10 detects the object 10 within a capturing range of the imaging device 50.

FIG. 7A and FIG. 7B are a flowchart of the processes performed by the server 30, according to the present embodiment.

These processes are controlled by the controller of the server 30. Firstly, the data that the receiver 36 has received from the detector 40 is output to the identification information analyzer 31, and the tag information is analyzed by the identification information analyzer 31. As a step of inputting data to the integration unit 33 the result of analysis performed on the tag information is obtained from the identification information analyzer 31 (step S001). The obtained information includes information indicating that no data has been obtained (data is unobtainable).

Subsequently, the relationship between the receivable range of the detector 40 and the capturing range of the imaging device 50 is referred to based on a table similar to the table as depicted in FIG. 6A (step S002). More specifically, the relation between the receivable range of the detector 40 (the region data that is estimated from the information obtained from the tag 20) and the position information estimated from the captured images is referred to, and the coordinates of the receivable range and the estimates positions are compared with each other. For example, the positions may be estimated from the image of the previous frame. Alternatively, the positions may be estimated from the position at which the camera is disposed and the settings of the camera (for example, the focal length of the lens).

Then, the receivable range of the detector 40 and the capturing range of the imaging device 50 are compared with each other based on the table (step S002), and whether or not the receivable range of the detector 40 is within the capturing range of the imaging device 50 is determined (S003). When the receivable range of the detector 40 is outside the capturing range of the imaging device 50 and the tag 20 exists within the receivable range of the detector 40, it is determined that the tag 20 exists outside the capturing range of the imaging device 50. In such a case, as position information, the receivable range of the detector 40 (outside the capturing range) is associated with the tag information (this tag information may be referred to as tag ID in the following description) (step S004).

When the receivable range of the detector 40 is within the capturing range of the imaging device 50, the receiver 37 of the server 30 receives the data in order to analyze the captured images, and the received image data is output to the image analyzer 32. Consequently, analytical processing is performed (step S005). As the load of the analytical processing of image is heavy, only when the object 10 is detected inside the capturing range of the imaging device 50 and the process proceeds to the tag ID integration (associating process), such analytical processing of image is performed.

Then, the result of analysis of the captured images is obtained from the image analyzer 32 (step S006), and whether or not the position (coordinates) can be estimated based on the result of analysis of the captured images is determined (step S007).

When the position (coordinates) can be estimated based on the result of analysis of the captured images, whether or not the position (coordinates) estimated based on the captured image exists within the receivable range of the detector 40 estimated from the tag information is determined (step S008).

When the position (coordinates) estimated based on the captured image exists inside the receivable range of the detector 40 estimated from the tag information, whether or not the estimated position (coordinates) is same as the position previously registered with the database is determined (step S009).

When the estimated position (coordinates) is different from the previously-registered estimated position (coordinates), the position (coordinates) estimated based on the image is associated with the tag ID (step S010). By contrast, when the estimated position (coordinates) is same as the previously-registered estimated position (coordinates), the tag ID is associated with the previously-estimated position (step S011).

On the other hand, when the position (coordinates) estimated based on the captured image does not exist within the receivable range of the detector 40 estimated from the tag information, whether the past position information with the same tag ID exists is determined (step S012). When the past position information with the same tag ID exists, the tag ID is associated with the previously-estimated position (step S011) Such an operation is performed, for example, when the object 10 that is detected within the capturing range of the imaging device 50 has later moved to a position that cannot be detected by the detector 40 within the capturing range. In the present embodiment, the estimating processes of the position by the image analyzer continue even in such a situation.

By contrast, when the past position information with the same tag ID does not exist, the association between the position information (coordinates) and the tag ID cannot be formed. Also, when the tag 20 is not recognized by the detector 40 whose receivable range covers the position (coordinates) estimated from the image, the association between the position information (coordinates) and the tag ID cannot be formed. In such a situation there is a possibility that the object 10 does not wear the tag 20. For this reason, the estimated position (coordinates) is associated with stranger information to indicate that the object 10 is a stranger (step S013).

When it is determined in the step S007 that the position (coordinates) cannot be estimated based on the result of analysis of the captured images, i.e. when the position (coordinates) cannot be estimated based on the result of analysis of the captured images in spite of the fact that the receivable range of the detector 40 is within the capturing range of the imaging device 50, for example, there is a possibility that the object 10 who wears the tag 20 exist in the blind spot of the imaging device 50, which cannot be captured by the imaging device 50. In such a situation the tag ID is associated with the position (range) estimated from the tag information.

Regarding the position (range) estimated from the tag information, whether or not the estimated position (range) is same as the position previously registered with the database is determined (step S014).

When the estimated position (range) is different from the previously-registered estimated position (range), the tag ID is associated with the position (range) estimated from the tag information (step S015).

By contrast, when the estimated position (range) is same as the previously-registered estimated position (range), the tag ID is associated with the previously-estimated position (step S016).

In the above step S014 whether or not the position (range) estimated from the tag information is same as the position previously registered with the database may be determined based on the position information of the detector 40 and the level of signal strength received from the identification information transmitter 20. For example, the position (range) estimated from the tag information may be determined to be close to the detector 40 when the level of the signal strength from the identification information transmitter 20 is high. On the other hand, for example, the position (range) estimated from the tag information may be determined to be far from the detector 40 when the level of the signal strength from the identification information transmitter 20 is low. Alternatively, the level of the signal strength may be compared with a predetermined threshold to determine to which one of the step S016 and the step S015 the process is to proceed, depending on the result of the comparison.

The data associated in the above steps S010, S011, S013, and S016 is registered with the database 34 (step S017). Then, whether or not all of the obtained results of detection has been judged is determined (step S018), and when it is determined that not all of the obtained results of detection has been judged, the process return to the comparison based on the table as in the step S002 again and the process continues.

When it is determined that all of the obtained results of detection has been judged (“YES” in the step S108), whether or not to terminate the detection is determined (step S019) When it is determined that the detection is not to be terminated (“NO” in the step S108), the result of analysis performed on the tag information is obtained again (step S001), and the processes of detection and determination are repeated on the next frame or an object appearing after a certain length of time has passed. Basically, the above processes are continued on a long-term basis, and the detection is terminated only when the system is in a sleep mode or during the maintenance and inspection of the system.

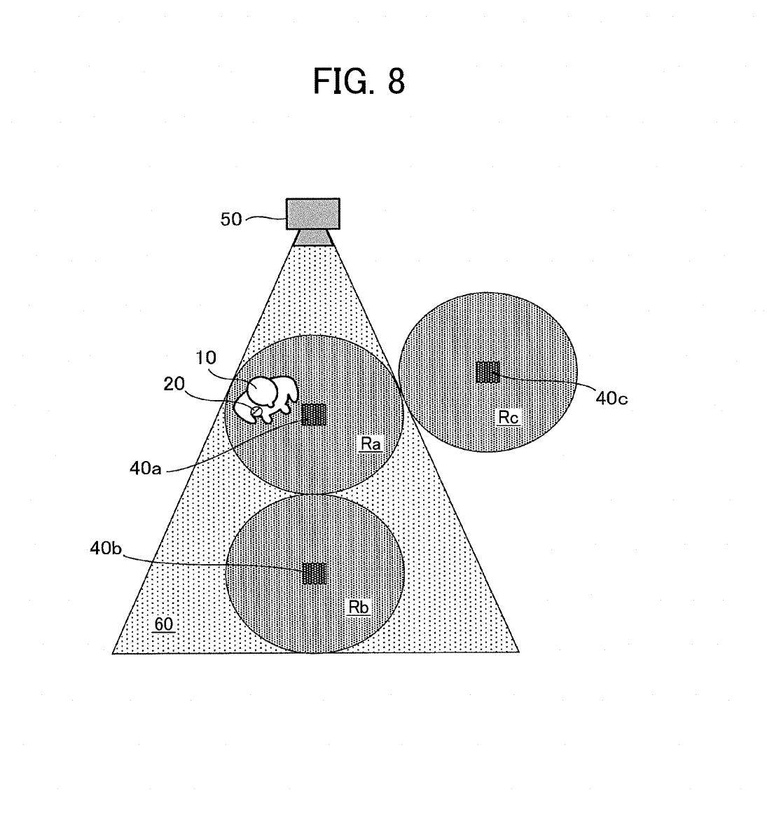

Some modes in which the position of the object 10 is estimated are described below with reference to FIG. 8 to FIG. 13. In a similar manner to FIG. 6B, FIG. 8 to FIG. 13 are top-view schematic diagrams each illustrating the relation between a capturing range of the imaging device 50 and several detectable areas of a plurality of detectors, according to the present embodiment. The schematic diagrams of FIG. 8 to FIG. 13 schematically illustrate the relative positions of a person (i.e., the object 10) and a plurality of ranges, and do not indicate the relative sizes of these elements. Moreover, the number of the detectors arranged in these drawings is not limited to the examples as depicted in these drawings. The processes in each mode are performed by the server 30 as illustrated in FIG. 2, and the integration unit 33 of the server 30 stores the table as illustrated in FIG. 6A.

First Mode

In FIG. 8, the imaging device 50, the capturing range 60 of the imaging device 50, three detectors 40 (40a, 40b, 40c) receivable ranges R (Ra, Rb, Rc) of the multiple detectors 40, and one figure of the object 10 wearing the tag 20 are illustrated.

In the present mode, the table depicts the relation between the capturing range 60 and the receivable ranges Ra, Rb, and Rc of the multiple detectors 40. In the present mode, the tag 20 is detected by the detector 40a. Moreover, the person (i.e., the object 10) is detected inside the capturing range 60.

According to the above table, it is identifiable that the person (i.e., the object 10) detected in the image captured by the imaging device 50 is the person who wears the tag 20. Based on this result of identification, the tag information and the position information of the person (i.e., the object 10) are associated with each other and registered in the database 34.

Second Mode

In FIG. 9, the imaging device 50, the capturing range 60 of the imaging device 50, the three detectors 40 (40a, 40b, 40c), the receivable ranges R (Ra, Rb, Rc) of the multiple detectors 40, and one figure of the object 10 wearing the tag 20 are illustrated.

In the present mode, the tag 20 is detected by the detector 40c, but the person (i.e., the object 10) is not detected inside the capturing range 60.

As the person (i.e., the object 10) is not detected from the image captured by the imaging device 50, it is determined in view of the above table that the person (i.e., the object 10) who wears the tag 20 is within the receivable range Rc of the detector 40c, which is outside the capturing range 60. Based on this result of identification, the tag information and the position information of the person (i.e., the object 10) are associated with each other and registered in the database 34.

Third Mode

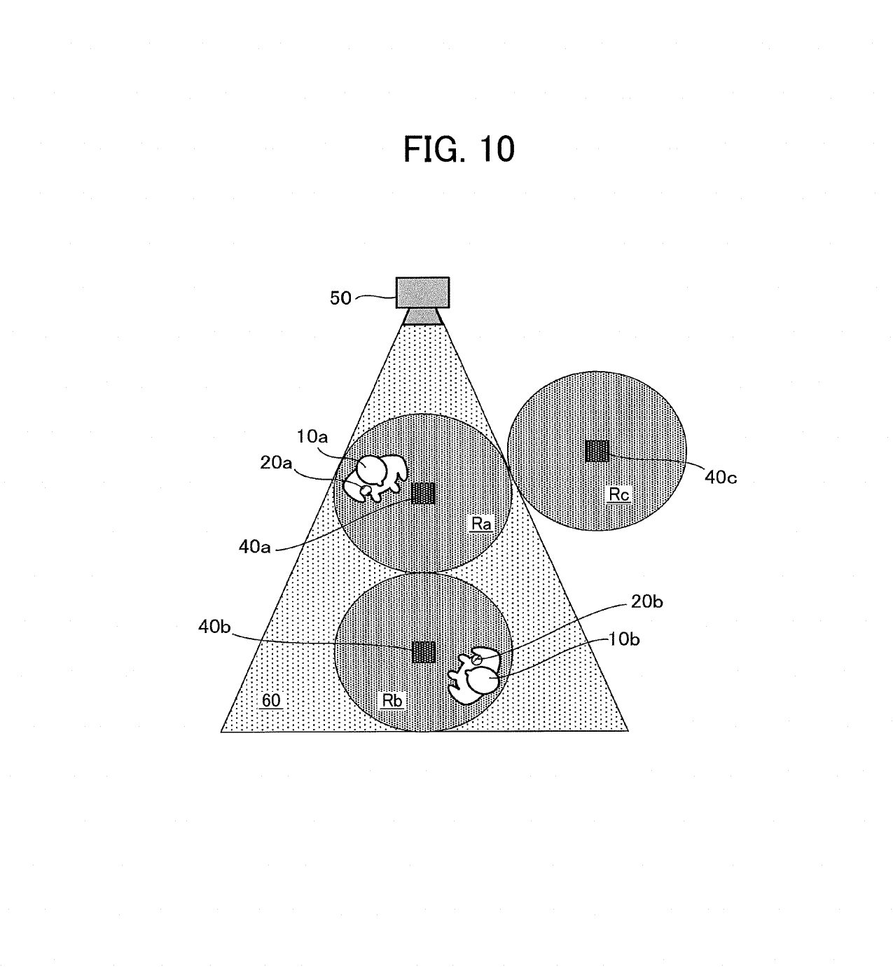

In FIG. 10, the imaging device 50, the capturing range 60 of the imaging device 50, the three detectors 40 (40a, 40b, 40c), the receivable ranges R (Ra, Rb, Rc) of the multiple detectors 40, and two figures including a person (object l0a) wearing a tag 20a and the other person (object 10b) wearing a tag 20b are illustrated.

In the present mode, the tag 20a is detected by the detector 40a, and the tag 20b is detected by the detector 40b. In other words, two persons (i.e., the objects to be detected l0a and 10b) are detected in the capturing range 60.

As the person (i.e., the object l0a) who is at a position closer to the imaging device 50 than the other person (i.e., the object 10b) is detected by the detector 40a, it is determined in view of the above table that the person (i.e., the object l0a) wears the tag 20a. In a similar manner, as the other person (i.e., the object 10b) who is at a position further from the imaging device 50 than the other person (i.e., the object l0a) is detected by the detector 40b, it is determined that the other person (i.e., the object 10b) wears the tag 20b. Based on this result of determination, the tag information and the position information of each of the persons (i.e., the objects to be detected l0a and 10b) are associated with each other and registered with the database 34.

Fourth Mode

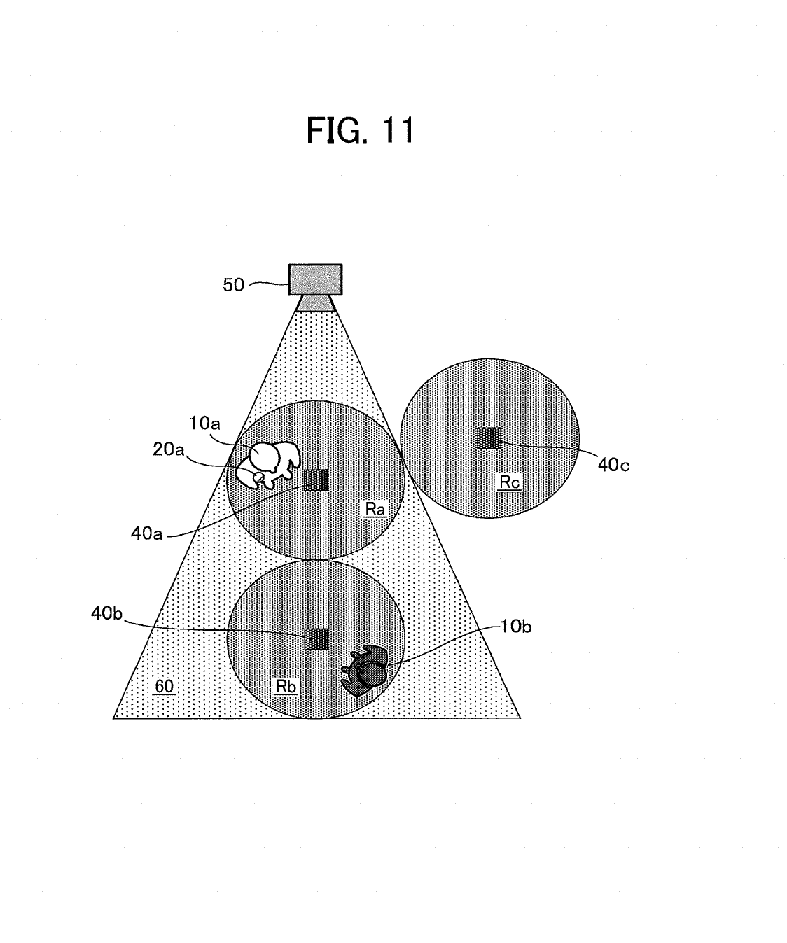

In FIG. 11, the imaging device 50, the capturing range 60 of the imaging device 50, the three detectors 40 (40a, 40b, 40c), the receivable ranges R (Ra, Rb, Rc) of the multiple detectors 40, and two figures including the person (object l0a) wearing the tag 20a and the other person (object 10b) not wearing any tag are illustrated.

In the present mode, the tag 20a is detected by the detector 40a. Although the person (i.e., the object 10b) is within the receivable range Rb of the detector 40b he/she is not detected by the detector 40b because he/she does not wear any tag. On the other hand, two persons (i.e., the objects to be detected 10a and 10b) are detected by the imaging device 50.

As the person (i.e., the object l0a) who is at a position closer to the imaging device 50 than the other person (i.e., the object 10b) is detected by the detector 40a, it is determined in view of the above table that the person (i.e., the object 10a) wears the tag 20a. By contrast as the person (i.e., the object 10b) who is at a position further from the imaging device 50 than the other person (i.e., the object 10a) is not detected by the detector 40b, the person (i.e., the object 10b) is regarded as a stranger. Based on this result of identification, the tag information and the position information of the person (i.e., the object 10a) are associated with each other and registered in the database 34. On the other hand, the person (i.e., the object 10b) who is regarded as a stranger is not registered with the database. However, the estimated position may be registered with the database upon being associated with stranger information.

Fifth Mode

In FIG. 13 the imaging device 50, the capturing range 60 of the imaging device 50, the three detectors 40 (40a, 40b, 40c), the receivable ranges R (Ra, Rb, Rc) of the multiple detectors 40, and one figure of the object 10 wearing the tag 20 are illustrated. FIG. 13 illustrates a state in which for example, the person (i.e., the object 10), as depicted in the first mode of FIG. 8, whose tag information and position information are associated with each other and registered with the database 34 has later moved to a position inside the capturing range 60, which is not detected by the detectors 40 (40a, 40b).

In the present mode, the person (i.e., the object 10) is detected within the capturing range 60. However, the tag 20 is not detected by the detector 40a or the detector 40b. In this situation, whether the past position information with the same tag exists is determined. When it is determined that such past position information with the same tag ID exists, the tag information and the position information obtained from the previously-captured images are associated with each other and registered.

Afterward, when the person (i.e., the object 10) who is detected within the capturing range 60 of the imaging device 50 has moved to a position that cannot be detected by the detectors 40 (40a, 40b) within the capturing range 60 in the object sensing system according to the present mode, the estimating processes of the position of the object 10 by the image analyzer 32 continue. In other words, even when the person (i.e., the object 10) goes out of the area that can be detected by a receiver, tagging can be continued as long as the person (i.e., the object 10) is kept being detected by the imaging device 50.

Sixth Mode

The object sensing system 1 according to the present embodiment can estimate the position of the object 10 and the posture of the object 10 based on the information received by the detector 40 and/or the image captured by the imaging device 50.

In the posture estimation, for example, a walking state or squatting posture can be detected by the tag 20 that is attached to a waist position of a person but the movement of a hand that does not wear a tag cannot be detected. By contract, when estimation is performed based on the image captured by the imaging device 50, various kinds of posture or motion can be recognized by learning.

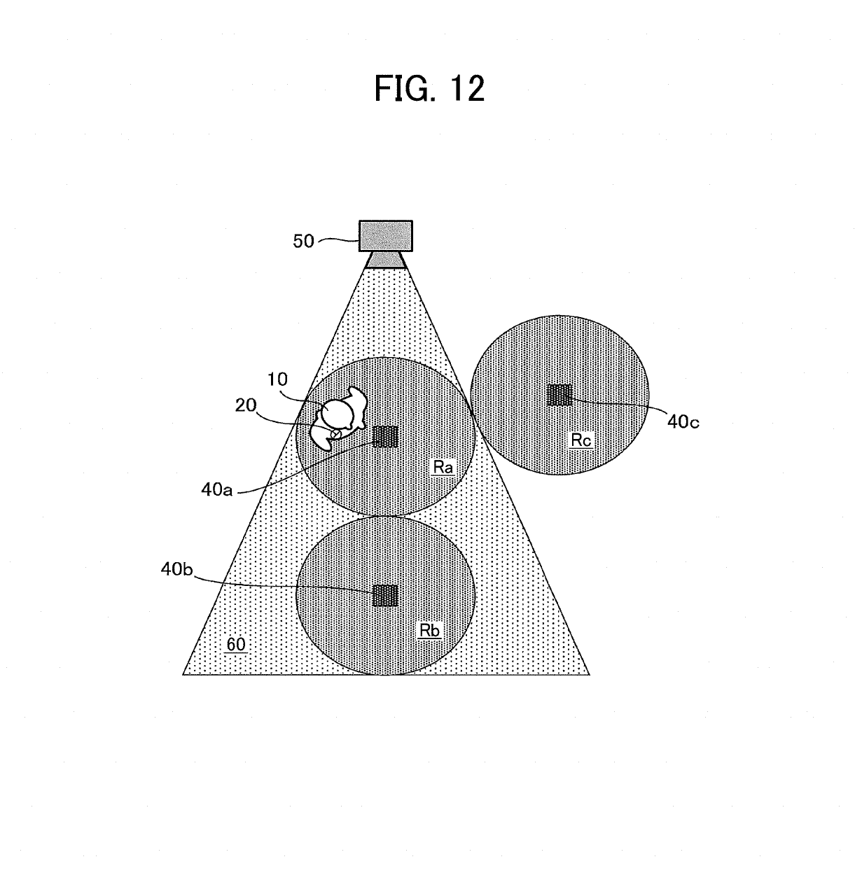

In a similar manner to FIG. 8, in FIG. 12, the imaging device 50, the capturing range 60 of the imaging device 50, the three detectors 40 (40a, 40b, 40c), the receivable ranges R (Ra, Rb, Rc) of the multiple detectors 40, and one figure of the object 10 wearing the tag 20 are illustrated. In a similar manner to FIG. 8, the person (i.e., the object 10) can be identified by both the image and tag information. Accordingly, it is considered that the posture or motion can be estimated with a high degree of precision.

Based on the obtained result of estimation, the tag information, the position information, and the posture information of the person (i.e., the object 10) are associated with each other and registered in the database 34.

In the configuration as illustrated in FIG. 9, the posture cannot be estimated based on the image captured by the imaging device 50. Accordingly, the posture is estimated based on the data obtained from the detectors 40. Based on the obtained result of estimation, the tag information, the position information, and the posture information are associated with each other and registered in the database 34.

As described above, with the object sensing system 1 according to the present embodiment, the data obtained from the tag 20 and the data obtained from the image captured by the imaging device 50 can be complementarily combined with each other. Accordingly, for example, the position information of the object 10 can be estimated with a high degree of precision without loss. Moreover, even when it is difficult to identify an object, detection processes can be performed with high accuracy while reducing the load on the system.

Program

A program that is executed in the object sensing system 1 according to the present embodiment is as follows. An object sensing system includes the identification information transmitter 20 that is attached to the object 10 and transmits the identification information of the object 10, the detector 40 that receives the identification information signals transmitted from the identification information transmitter 20 and detects the object 10, the imaging device 50, the image analyzer 32 that estimates, at least, the position of the object 10 upon performing image processing on the image captured by the imaging device 50, and the controller. A computer-readable non-transitory recording medium provided for the object sensing system stores a program for causing the image analyzer 32 to perform different processes depending on whether or not the object 10 is detected by the detector 40 within a capturing range of the imaging device 50. In other words, with the program according to the present embodiment When the object 10 is detected by the detector 40 within a capturing range of the imaging device 50, the image analyzer 32 estimates the position of the object 10 upon performing image processing on the object 10. When the object 10 is not detected by the detector 40 within a capturing range of the imaging device 50, the image analyzer 32 does not perform image processing on the object 10, and the position of the object 10 is estimated by the detector 40.

A program for the object sensing system 1 according to the above-described embodiment may be installed for distribution in any desired computer-readable recording medium such as a compact disc, a read-only memory (CD-ROM), a flexible disk (FD), a compact disc-recordable (CD-R), and a digital versatile disk (DVD), a universal serial bus (USB) in a file format installable or executable by a computer, or may be provided or distributed via network such as the Internet. Alternatively, various kinds of programs may be integrated in advance, for example, into a read only memory (ROM) inside the device for distribution.

Numerous additional modifications and variations are possible in light of the above teachings. It is therefore to be understood that within the scope of the appended claims, the disclosure of the present disclosure may be practiced otherwise than as specifically described herein. For example, elements and/or features of different illustrative embodiments may be combined with each other and/or substituted for each other within the scope of this disclosure and appended claims.

What is claimed is:

1. An object sensing system comprising:
an identification information transmitter attached to an object, the identification information transmitter configured to transmit a signal of identification information of the object;
a detector configured to receive the signal of the identification information transmitted from the identification information transmitter and detect the object;
an imaging device configured to capture an image within a capturing range of the imaging device;
circuitry configured to perform image processing on the image captured by the imaging device and estimate, at least, a position of the object, the image processing being performed differently depending on whether the object is detected by the detector within the capturing range of the imaging device.

2. The object sensing system according to claim 1,
wherein, when the object is detected by the detector within the capturing range of the imaging device, the circuitry performs image processing on the object,
wherein, when the object is not detected by the detector within the capturing range of the imaging device, the circuitry does not perform the image processing on the obj ect.

3. The object sensing system according to claim 1, wherein the circuitry associates the identification information of the object with information of the estimated position of the object.

4. The object sensing system according to claim 1, wherein, when the object that is detected within the capturing range of the imaging device has moved to a position that cannot be detected by the detector within the capturing range, the circuitry continues estimating the position of the object.

5. The object sensing system according to claim 1, wherein, when the object that is detected within the capturing range of the imaging device has moved outside the capturing range or has moved to a position that cannot be captured by the imaging device, the circuitry estimates the position of the object based on the identification information received by the detector.

6. The object sensing system according to claim 1, wherein the circuitry estimates the position of the object based on the identification information received by the detector, position information of the detector, and a level of strength of the signal received from the identification information transmitter.

7. The object sensing system according to claim 1,
wherein the object is a person,
wherein, when the position of the object is estimated, posture of the object is estimated based on at least one of the identification information received by the detector and the image captured by the imaging device.

8. A method of detecting an object, the method comprising:
transmitting a signal of identification information of the object, using an identification information transmitter attached to the object;
receiving the signal of the identification information transmitted from the identification information transmitter, using a detector;
detecting the object based on the signal of the identification information obtained in the receiving, using the detector;
capturing the object using an imaging device;
performing image processing on the object when the object is detected by the detector within the capturing range of the imaging device, the image processing being performed differently when the object is not detected by the detector within the capturing range of the imaging device; and
estimating at least a position of the object.

9. A computer-readable non-transitory recording medium storing a program for causing a computer to execute a method, the method comprising
transmitting a signal of identification information of the object, using an identification information transmitter attached to the object;
receiving the signal of the identification information transmitted from the identification information transmitter, using a detector;
detecting the object based on the signal of the identification information obtained in the receiving, using the detector;
capturing the object using an imaging device;
performing image processing on the obj ect when the object is detected by the detector within the capturing range of the imaging device, the image processing being performed differently when the object is not detected by the detector within the capturing range of the imaging device; and
estimating at least a position of the object.
